(19) United States
(12) Patent Application Publication
(10) Pub. No.: US 2013/0318859 A1
(43) Pub. Date: Dec. 5, 2013

(54) WEIGHTED KEEPER AND HOOK APPARATUS FOR ANGLERS

(71) Applicants: Glenn Stanley Kusmerz, Lake Worth, FL (US); Thomas Durwood Lewis, Ft. Pierce, FL (US)

(72) Inventors: Glenn Stanley Kusmerz, Lake Worth, FL (US); Thomas Durwood Lewis, Ft. Pierce, FL (US)

(21) Appl. No.: 13/909,785

(22) Filed: Jun. 4, 2013

Related U.S. Application Data
(60) Provisional application No. 61/655,849, filed on Jun. 5, 2012.

(51) Int. Cl. A01K 83/06; A01K 83/00

(52) U.S. Cl. CPC A01K 83/06; A01K 83/00
USPC 43/44.81

(57) ABSTRACT

A weighted keeper having an elongated cylinder and a plurality of protrusions thereon. The plurality of protrusions may comprise a wide variety of different shapes and configurations for maintaining bait on the weighted keeper. In one embodiment, a weighted keeper with conical barbs may be disposed about a pin or wire to support live bait or an artificial dressing. The keeper wire may provide a keeper eye at one end of the weighted keeper and a wire tip at the opposing end of the weighted keeper. The keeper eye may be attached to the eye of any fishhook known within the art and the wire tip may assist in piercing and mounting the bait onto and about the surface of the weighted keeper. The attached bait is provided with beneficial performance characteristics that more accurately mimic or replicate the movement of live bait fish.

### CROSS REFERENCE TO RELATED APPLICATIONS

This non-provisional patent application claims priority to provisional patent application Ser. No. 61/655,849 filed in the U.S. Patent and Trademark Office on Jun. 5, 2012 and which is incorporated herein by reference in its entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

This invention relates to an improved bait holding attachment for fishhooks. More particularly, the invention relates to an improved, simplified arrangement for securing bait, both natural and artificial, onto a weighted keeper and fishhook in different positions.

2. Background

Numerous devices are available to fisherman to retain dressings, live bait and other accessories to a fishhook or lure. Some fishhooks include barbs or burrs that flare from the shank of the hook. The barbs may be formed by peeling or shaving a portion of the shank to extend at a preferred angle. The barbs are formed to resist withdrawal of a dressing or live bait that is mounted over the barbs.

Pegs having a barbed shank and opposite ends that contain a point and an eyelet are available that mount to the eye of a hook or lure. The peg can be inserted into a portion of a dressing accessory, such as a molded plastisol member, which will then trail from the hook. Upon also attaching the barb of the hook to the dressing, the gap between the barb and hook eye can be sheltered to make the hook or lure “weedless”. Similar pegs are used to secure tippets to braided fly fishing lines.

Molded plastic keeper pegs also exist that have a barbless, elongated, spindle shaped shank, a point at one end and an eyelet at an opposite end, reference U.S. Pat. No. 5,904,001. Hooks that include the foregoing metal and plastic pegs are sold by Mister Twister under the brand names KEEPER HOOK and SMART HOOK.

U.S. Pat. No. 4,334,381 discloses a technique that only involves the point of the hook being embedded in the soft plastic. To secure the bait in the desired position, the hook utilizes an additional element which is a straight, rigid rod attached to the eye of the hook. The rod has a number of barbs along the shank, and is inserted axially into the end of a bait such as a plastic worm. In this manner, the rigid rod secures the head end of the worm, while the point of the hook is embedded into the body of the worm. The rod, while being rigid, has one end pivotally attached to the eye of the hook, so that it has some degree of movement, but once the bait is secured, no significant further movement is possible, since the rigidity of the rod prevents substantial flexing of the bait. Further, since the rod is rigid and straight, some rigging techniques which utilize a curved worm body are inhibited by this type of hook arrangement. A rigid body does not allow the movement of the artificial bait to mimic that of a live bait, and thus is not optimal for fishing. Furthermore, the rigid rod is also of a diameter substantially the same as, or even larger than, the diameter of the hook. This can cause tearing of the end of the worm during use, with the result that the worm would be discarded early.

U.S. Pat. No. 5,630,289 discloses a solid bodied plastic shaft that has a number of barbs that project transverse to the shaft. The barbed member is used to splice and/or to secure dressings to a lure.

U.S. Pat. No. 4,858,367 discloses a keeper peg that is molded into a jig head.

Jigs and lures have also been molded with body parts or appendages that include projecting barbs or a series of conical rings to support a dressing that is threaded over the appendage. Wires with spiral windings and other bend configurations have also been molded into or attached to various lures and hooks to retain desired dressings or live bait.

Wire and bristle weed guards also exist that are typically molded into the body of a lure. The guard typically is mounted to shelter the point of the hook from weeds, yet flex to expose the hook with the occurrence of a fish strike. However, because such weed guards are molded into the body of the lure they are not removable and reusable with soft plastic fishing baits or with live baits, nor do they provide any weight to the lure.

The weighted keeper hook of the present invention was developed to provide a novel and efficient fishing accessory that can be adapted to many different lure and hook presentations, such as live bait or artificial baits such as, for example, soft baits, or a dressing retainer and/or a weed guard while providing a more life-like lure response for triggering a greater amount of fish strikes. In one embodiment, the weighted keeper comprises an elongated cylinder having a plurality of conical barbs or protrusions that radiate from the central axis of the elongated cylinder. A hollow longitudinal bore and/or slot along the central axis may extend the length of the elongated cylinder. The weighted keeper may also be molded over a formable wire substrate or braided wire substrate. The weighted keeper hook of the present invention improves the conventional keeper hooks by modifying the physical characteristics of the device in such a way as to enhance the performance of the device and greatly improve an angler's success when using the device in the field.

### BRIEF DESCRIPTION OF THE DRAWINGS

FIG. 1 depicts a side planar view of a preferred embodiment of a weighted keeper and hook of the present invention.

FIG. 2 depicts a side planar view of a preferred embodiment of a weighted keeper of the present invention.

FIG. 3 depicts a side planar view of a preferred embodiment of a weighted keeper of the present invention.

FIG. 4 depicts a longitudinal sectional view of a preferred embodiment of a weighted keeper and hook of the present invention used in combination with a bait.

FIG. 5 depicts a cross sectional view of a preferred embodiment of the invention showing a keeper wire extending through an elongate cylinder of the invention.

FIG. 6 depicts a cross sectional view of a preferred embodiment of the invention showing a keeper wire terminating within an elongate cylinder of the invention.

### DETAILED DESCRIPTION OF THE INVENTION

Although a detailed description as provided in the attachments contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention. Thus the scope of the invention should be determined by the appended claims and their legal equivalents, and not by the examples given.

The fields of fishing tackle, lures, and bait contain a wide range of prior art geared toward increasing the productivity and effectiveness of an angler achieving a strike on their particular lure or bait option. Most prior art devices attempt to mimic or replicate the visual cues, movement patterns, and/or emitted scents and the like of the various natural food sources for the respective target fish species. The greater the similarities of the artificial tackle to the fish's natural food source, the implied greater effectiveness of the artificial tackle.

A keeper hook of the background art typically comprises a fishhook having a weight already provided on its shank, or a weight may be attached to the shank of the hook by the user. The background art keeper generally comprises an elongated plastic component having a number of surface features wherein the prior art keeper is attached to the eye of a fishhook. Live or artificial bait may be placed over the background art keeper, however, with the weight attached to the shank of the fishhook the jigging action resulting from such a device is quite different from the visual cues and movement patterns of a wide range of the bait fish that anglers are attempting to mimic. When bait fish sense a predator fish in the area, they tend to dart straight down into vegetation. The mechanical structure of the background art hook keepers does not allow the background device to drop straight to the bottom, but rather the background art devices drop at a thirty degree to forty-five degree angle. This is unlike live bait fish, which generally dart straight down, nose-first into the vegetation. Thus, the structure and resulting motion accomplished by the background art keeper hooks is far from optimal and improvements are needed to more accurately mimic or reflect the natural visual cues and/or movement patterns provided by live bait fish. The present invention overcomes this problem.

The weighted keeper hook of the present invention solves the problem of background art devices not being able to closely replicate the behavior and movement patterns of live bait fish. The weighted keeper hook of the present invention includes unique structural improvements over the background art, for example placing the weight into the nose of the artificial bait, that dramatically alter an artificial bait's movement pattern in the water and allow it to more precisely replicate live bait motion, thereby greatly improving the effectiveness and number of fish strikes achieved.

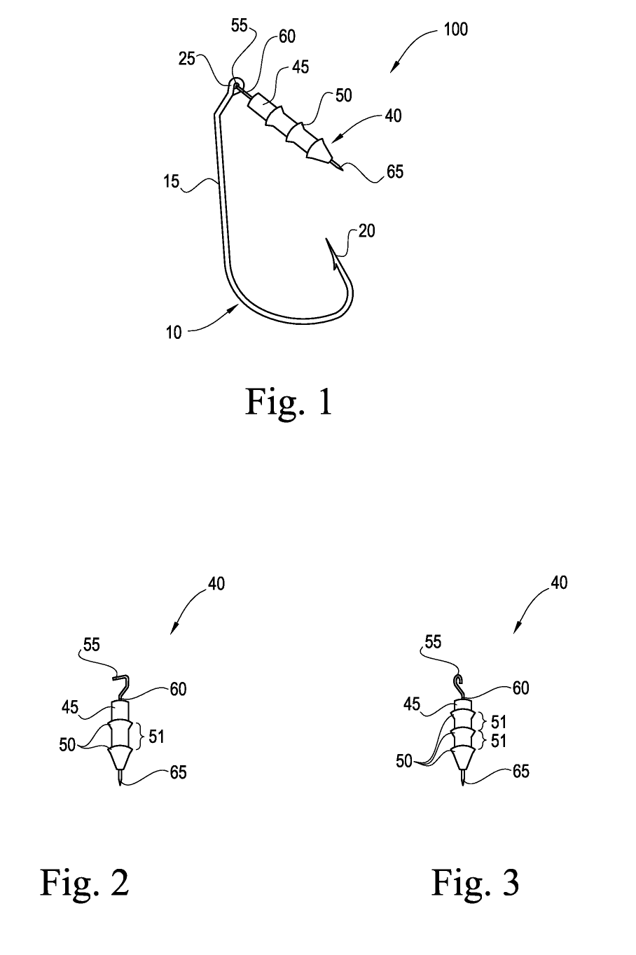

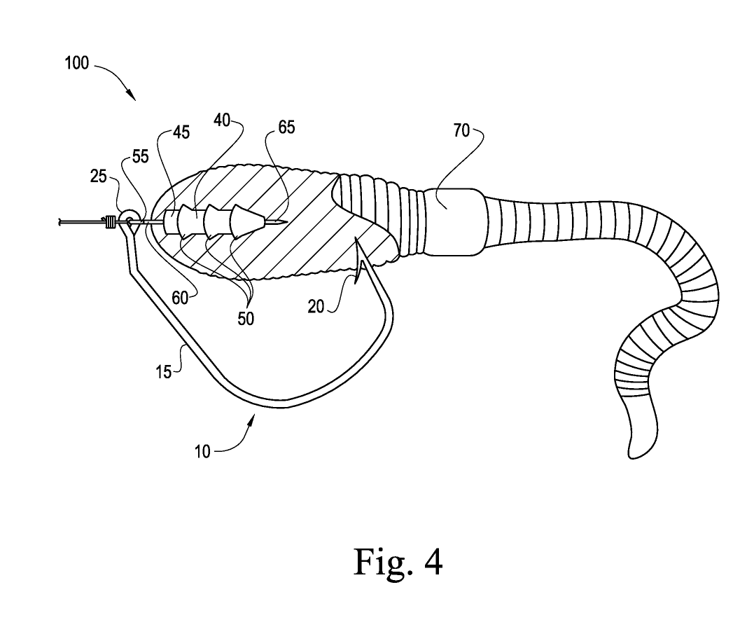

FIG. 1 illustrates a preferred embodiment of a weighted keeper and hook 100 of the present invention. A preferred embodiment of the invention may comprise a conventional fishhook 10 and a novel weighted keeper 40. The conventional fishhook may include any hook style preferred by the angler and may comprise a shank 15, a curvilinear hook and a barb 20 at the distal end of shank 15, and an eye 25 disposed at the proximal end of shank 15. The weighted keeper hook 100 of the embodiment shown in FIG. 1 incorporates the weight 30 into the keeper portion forming a weighted keeper 40. Placing the weighted keeper 40 inside the bait was found to dramatically improve the movement characteristics of the bait 70 (not shown in FIG. 1, but shown in FIG. 4) over the background art when it is incorporated onto a weighted keeper and hook 100 of the present invention (see FIG. 4). By situating the weight into the nose portion of the bait 70 by sliding the bait 70 onto the weighted keeper 40, the jigging action of the weighted keeper and hook 100 was found to be greatly improved and more accurately replicate the movement of live bait fish. These unanticipated results represent a great improvement over the prior art. Keeper eye 55, keeper wire 60, elongated cylinder 45, protrusions 50 and pin tip or wire tip 65 are shown for reference in FIG. 1 and are described in more detail below.

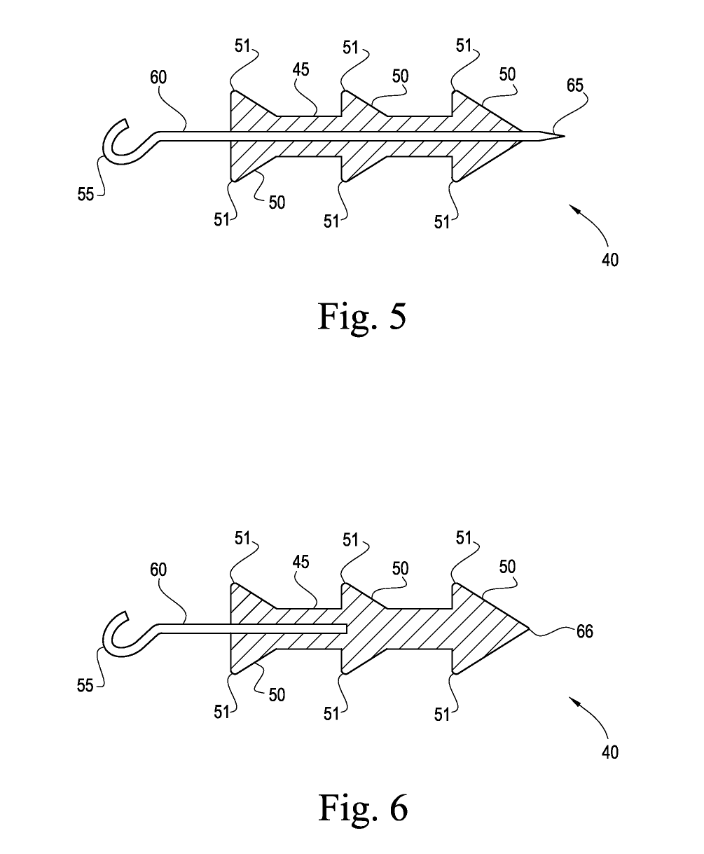

While FIG. 1 illustrates one embodiment of a weighted keeper and hook 100 of the present invention, FIGS. 2-3 illustrate two preferred embodiments of weighted keepers 40. Weighted keepers 40 of the present invention may comprise an elongated cylinder 45 from which a plurality of protrusions 50 may radiate. The plurality of protrusions 50 may include but are not limited to barbs, conical barbs, flanged ribs, projections, screw threads, prongs, hooks, and the like. The plurality of protrusions 50 may be separated by a gap 51 along the elongated cylinder 45. The bait 70 (not shown in FIGS. 2-3 but shown in FIG. 4), such as live bait or dressing, may be threaded onto or pulled over the weighted keeper 40 encompassing the elongated cylinder 45 and the plurality of protrusions 50. The bait 70 may also be pulled onto the tip or barb 20 of the fishhook 10. The circumference of the elongated cylinder 45 and the plurality of protrusions 50 may retain the bait 70 or dressing to the weighted keeper 40. Cylindrical edges 51 (not shown in FIGS. 2-3 but shown in FIGS. 5-6) on the plurality of protrusions 50 may facilitate removal of certain dressings without tearing or shredding the dressing.

The weighted keeper 40 may be molded from a variety of materials including but not limited to lead, tungsten, brass, tin, bismuth, steel, and any other materials known within the art for imparting mass to cause tackle to sink when placed in a body of water. The weight of such materials assures that the weighted keeper 40 provides a vertical fall during jigging action since the weight is centered within the nose portion of the bait 70.

The weighted keeper 40 may be of unitary construction or, as shown in the preferred embodiment of FIGS. 1-4, the weighted keeper 40 may be cast or molded about a metal pin or keeper wire 60. The elongated cylinder 45 of the weighted keeper 40 may also be constructed with a longitudinal bore through which the keeper wire 60 may extend. In one embodiment, the keeper wire 60 may extend all the way through the elongated cylinder 45 and a pin tip or wire tip 65 may exit the opposing end of the elongated cylinder 45 to provide a penetrating point that assists in piercing the bait 70 and then moving the bait 70 onto the weighted keeper 40. In such an embodiment, the weighted keeper 40 may be molded about the keeper wire 60 wherein the keeper wire 60 may comprise either a solid or multi-stranded configuration. In an alternate embodiment, the keeper wire 60 may terminate within the elongated cylinder 45 and the end of the weighted keeper 40 may provide a penetrating point in the form of a sharp point or edge 66 on elongated cylinder 45 (not shown in FIGS. 1-4 but shown in FIG. 6) to facilitate placement of the bait 70 thereon. Keeper eye 55 may be disposed on a proximal end of weighted keeper 40.

The diameter and taper of the plurality of protrusions 50 may be sized as desired. The shape of the plurality of protrusions 50 may also be varied and protrusions of many different shapes and sizes can be included alone or in combination along the weighted keeper 40. In a preferred embodiment, the plurality of protrusions 50 comprise a conical or frustum shape (see FIG. 3 having two conical barbs; and FIG. 4 having three conical barbs), although they may exhibit a variety of other tapered shapes, such as but not limited to a pyramidal or elliptical cross sectional shape, when view end-on. The spacing 51 between the respective protrusions comprising the plurality of protrusions 50 may also be varied. The shape and positioning of the plurality of protrusions 50 provide resistance to premature withdrawal of bait 70 or dressing once threaded or pulled onto the weighted keeper 40.

As shown in FIGS. 1 and 4, a fishhook 10 is shown having an eye 25 to which keeper eye 55 may be attached. One end of the keeper wire 60 of the weighted keeper 40 may be bent to provide that keeper eye 55 interlocks and may therefore be rotatably engaged with eye 25 of fishhook 10. The rotatable engagement of the fishhook eye 25 and keeper eye 55 allows the weighted keeper 40 to pivot and move freely relative to the fishhook 10. Bait 70 such as a plastisol dressing molded to a preferred shape (e.g. worm, eel, crayfish, salamander, lizard, cricket, minnow or other natural bait imitation) may be threaded or pulled onto the weighted keeper 40 to secure the bait 70 to the weighted keeper 40. As shown in FIG. 4, the barb 20 of the fishhook 10, if separately attached to the bait 70, may create a weedless presentation when the weighted keeper hook 100 is used in the field.

FIG. 4 depicts a preferred embodiment of the weighted keeper and hook 100 of the present invention in use. In such an embodiment, the weighted keeper 40 may be disposed onto a keeper wire 60 having a keeper eye 55 disposed on a proximal end of the weighted keeper 40 and penetrating point disposed on a distal end of the weighted keeper 40 which may comprise a pin or wire tip 65 exposed on the distal end of the weighted keeper 40, or may comprise a sharp point disposed on the distal end of weighted keeper 40. The keeper eye 55 may attach to the eyelet 25 of any fishhook 10 known within the art. The pin or wire tip 65 (or pointed end of the weighted keeper 40 in other embodiments) may be inserted into the front of the bait 70. The bait 70 may then be pushed onto the weighted keeper 40, wherein the outer surface of the weighted keeper 40 and/or the plurality of protrusions 50 thereon retain the bait 70 about the weighted keeper 40 and prevent the bait 70 from being pulled off when a fish bites the weighted keeper and hook 100. With the bait 70 on the weighted keeper 40, the tip or barb 20 of the fishhook 10 may be pushed into the under belly or other portion of the bait 70 to assist in preventing snags and making the weighted keeper hook “weedless” in nature. When a fish strikes the bait 70 the weighted keeper 40 and bait 70 thereon hinge towards the shank 15 of the fishhook 10 thereby opening the hook gap allowing a positive hook set when a fish has struck the weighted keeper and hook 100. The unique structure of the weighted keeper and hook 100 of the present invention moves and combines the weighted portion of the assembly into the weighted keeper 40 that is disposed within the nose or front of the bait 70.

Referring now to FIG. 5, a cross sectional view of a preferred embodiment of the weighted keeper 40 of the invention is shown in which three protrusions 50 are shown. It is understood that alternate embodiments may have more or less than three protrusions. In the embodiment depicted in FIG. 5, the weighted keeper 40 may be cast or molded about a metal pin or keeper wire 60. The elongated cylinder 45 of the weighted keeper 40 may also be constructed with a longitudinal bore through which the keeper wire 60 may extend. In one embodiment, the keeper wire 60 may extend all the way through the elongated cylinder 45 and a pin tip or wire tip 65 may exit the opposing end of the elongated cylinder 45 and assist in piercing the bait 70 (not shown in FIG. 5 but shown in FIG. 4) and then moving the bait 70 onto the weighted keeper 40. In such an embodiment, the weighted keeper 40 may be molded about the keeper wire 60 wherein the keeper wire 60 may comprise either a solid or multi-stranded configuration. Keeper eye 55 may be disposed on a proximal end of weighted keeper 40.

Referring now to FIG. 6, a cross sectional view of an alternate embodiment of the weighted keeper 40 of the invention is shown in which three protrusions 50 are shown. It is understood that alternate embodiments may have more or less than three (3) protrusions. In the embodiment depicted in FIG. 6, the weighted keeper 40 may be cast or molded about a metal pin or keeper wire 60. In one embodiment, the keeper wire 60 may extend partially through the elongated cylinder 45 and may terminate within elongated cylinder 45. Keeper wire 60 may thus terminate within the elongated cylinder 45 and the end of the weighted keeper 40 may provide a sharp point or edge 66 to assist in piercing the bait 70 (not shown in FIG. 5 but shown in FIG. 4) and then moving the bait 70 onto the weighted keeper 40. In such an embodiment, the weighted keeper 40 may be molded about the keeper wire 60 wherein the keeper wire 60 may comprise either a solid or multi-stranded configuration. Keeper eye 55 may be disposed on a proximal end of weighted keeper 40.

The improved structure of the weighted keeper and hook 100 of the present invention gives the bait 70 a straight up-and-down performance. Such a presentation provides a more realistic action that more accurately simulates real or natural bait fish movement. The weighted keeper 40 causes the surrounding bait 70 to fall straight down letting the bait 70 being used ride with its end floating straight up. Such a movement pattern caused by the device of the present invention creates a more natural live bait action when fished properly and thereby triggers more strikes. Background art keeper hooks tend to sink at an angle, and not straight down, as does the weighted keeper and hook 100 of the present invention. Thus the present invention more closely mimics the actions of natural bait, results in more strikes, and is an improvement in the state of the art.

The weighted keeper and hook 100 of the present invention may be provided in a variety of sizes and weights. In preferred embodiments, the weight of the weighted keeper 40 may range from 1/16 oz. to 1 oz. The weighted keepers 40 may be sold in combination and already installed onto a fishhook 10 in the form or weighted keeper and hook 100 as shown in FIG. 1. In the alternative, the weighted keepers 40 may be sold individually, as shown in FIGS. 2-3, allowing anglers to attach the weighted keepers 40 onto their own preferred aftermarket fishhooks 10. In such embodiments, the weighted keepers 40 may be sold with the keeper eye 55 open allowing an angler to later attach the weighted keeper 40 to preferred hooks by closing, crimping, or otherwise securing the open keeper eye 55 to a fishhook 10. The weighted keepers 40 of the present invention are fully adaptable and customizable and may be provided in any weight and may also be attached to any fishhook 10 known within the art.

What is claimed is:

1. A weighted keeper for use with a fishing hook, comprising an elongate cylindrical body having an outer circumference, a proximal end, and a distal end,
wherein said elongate cylindrical body further comprises a plurality of protrusions disposed upon said elongate cylindrical body outer circumference, and
wherein said cylindrical body proximal end further comprises a wire protrusion forming an eye; and
wherein said cylindrical body distal end is further defined as comprising a penetrating point.

2. The weighted keeper of claim 1, wherein said protrusions are further defined as being selected from the group consisting of conical barbs, elliptical barbs, pyramid-shaped barbs, barbs, flanged ribs, screw threads, prongs, projections and hooks.

3. The weighted keeper of claim 1, wherein said penetrating point is further defined selected from the group consisting of a pin protruding from said distal end of said elongate cylindrical body, a wire tip protruding from said elongate cylindrical body, and a sharp point formed in said distal end of said elongate cylindrical body.

4. The weighted keeper of claim 1, wherein said elongate cylindrical body is formed from a material selected from the group consisting of lead, tungsten, brass, tin, bismuth and steel.

5. The weighted keeper of claim 2,
wherein said penetrating point is further defined selected from the group consisting of a pin protruding from said distal end of said elongate cylindrical body, a wire tip protruding from said elongate cylindrical body, and a sharp point formed in said distal end of said elongate cylindrical body,
and wherein said elongate cylindrical body is formed from a material selected from the group consisting of lead, tungsten, brass, tin, bismuth and steel.

6. The weighted keeper of claim 1, wherein said weighted keeper weighs more than or equal to one-sixteenth ounces and less than or equal to one ounce.

7. The weighted keeper of claim 2, wherein said weighted keeper weighs more than or equal to one-sixteenth ounces and less than or equal to one ounce.

8. The weighted keeper of claim 3, wherein said weighted keeper weighs more than or equal to one-sixteenth ounces and less than or equal to one ounce.

9. The weighted keeper of claim 4, wherein said weighted keeper weighs more than or equal to one-sixteenth ounces and less than or equal to one ounce.

10. The weighted keeper of claim 5, wherein said weighted keeper weighs more than or equal to one-sixteenth ounces and less than or equal to one ounce.

11. A weighted keeper and hook apparatus, comprising:
a fishing hook comprising a shank having a proximal end and a distal end, wherein said proximal end further comprises an eyelet and said distal end further comprises a curvilinear hook; and
a weighted keeper comprising an elongate cylindrical body having an outer circumference, a proximal end, and a distal end, wherein said elongate cylindrical body further comprises a plurality of protrusions disposed upon said elongate cylindrical body outer circumference, and wherein said cylindrical body proximal end further comprises a wire protrusion forming a keeper eye; and wherein said cylindrical body distal end is further defined as comprising a penetrating point;
wherein said eyelet of said fishing hook and said keeper eye are rotatably attached.

12. The weighted keeper and hook apparatus of claim 11, wherein said protrusions are further defined as being selected from the group consisting of conical barbs, elliptical barbs, pyramid-shaped barbs, flanged ribs, screw threads, prongs, projections and hooks.

13. The weighted keeper and hook apparatus of claim 11, wherein said penetrating point is further defined selected from the group consisting of a pin protruding from said distal end of said elongate cylindrical body, wire tip protruding from said elongate cylindrical body, and a sharp point formed in said distal end of said elongate cylindrical body.

14. The weighted keeper and hook apparatus of claim 11, wherein said elongate cylindrical body is formed from a material selected from the group consisting of lead, tungsten, brass, tin, bismuth and steel.

15. The weighted keeper and hook apparatus of claim 12,
wherein said penetrating point is further defined selected from the group consisting of a pin protruding from said distal end of said elongate cylindrical body, a wire tip protruding from said elongate cylindrical body, and a sharp point formed in said distal end of said elongate cylindrical body,
and wherein said elongate cylindrical body is formed from a material selected from the group consisting of lead, tungsten, brass, tin, bismuth and steel.

16. The weighted keeper and hook apparatus of claim 11, wherein said weighted keeper weighs more than or equal to one-sixteenth ounces and less than or equal to one ounce.

17. The weighted keeper and hook apparatus of claim 12, wherein said weighted keeper weighs more than or equal to one-sixteenth ounces and less than or equal to one ounce.

18. The weighted keeper and hook apparatus of claim 13, wherein said weighted keeper weighs more than or equal to one-sixteenth ounces and less than or equal to one ounce.

19. The weighted keeper and hook apparatus of claim 14, wherein said weighted keeper weighs more than or equal to one-sixteenth ounces and less than or equal to one ounce.

20. The weighted keeper and hook apparatus of claim 15, wherein said elongate cylindrical body is formed from a material selected from the group consisting of lead, tungsten, brass, tin, bismuth and steel.
